(19) United States
(12) Patent Application Publication
(10) Pub. No.: US 2015/0256957 A1
(43) Pub. Date: Sep. 10, 2015

(54) USER TERMINAL DEVICE, AUDIO SYSTEM, AND METHOD FOR CONTROLLING SPEAKER THEREOF

(71) Applicant: SAMSUNG ELECTRONICS CO., LTD., Suwon-si (KR)

(72) Inventors: Ji-hyae KIM, Seoul (KR); Jung-geun KIM, Suwon-si (KR); Yong-jin SO, Seongnam-si (KR); Kie-chan NAMKUNG, Suwon-si (KR)

(73) Assignee: SAMSUNG ELECTRONICS CO., LTD., Suwon-si (KR)

(21) Appl. No.: 14/542,791

(22) Filed: Nov. 17, 2014

(30) Foreign Application Priority Data
Mar. 7, 2014 (KR) 10-2014-0027074

(51) Int. Cl. H04S 1/00; H04B 5/00

(52) U.S. Cl. CPC H04S 1/007; H04B 5/0031; H04S 2400/01

(57) ABSTRACT

A user terminal device, an audio system, and a method of controlling a speaker are provided. The method includes performing a pairing operation with a plurality of speakers, displaying a multi-channel setting user interface (UI) including identifiers of the plurality of speakers, and in response to a multi-channel setting command for at least two speakers from among the plurality of speakers being input through the multi-channel setting UI, transmitting a multi-channel setting command to the at least two speakers.

### CROSS-REFERENCE TO RELATED APPLICATION(S)

This application claims priority from Korean Patent Application No. 10-2014-0027074, filed in the Korean Intellectual Property Office on Mar. 7, 2014, the entire disclosure of which is incorporated herein by reference.

### BACKGROUND

1. Field

Apparatuses and methods consistent with exemplary embodiments relate to a user terminal device, an audio system, and a method of controlling speakers thereof, and more particularly, to a user terminal device that is capable of establishing a multi-channel audio environment using a plurality of speakers, an audio system, and a method of controlling the plurality of speakers.

2. Description of Related Art

With the development of recent communication technologies, a user may now control various external apparatuses using a portable user terminal. For example, a user may control an audio environment by controlling an external speaker through a portable user terminal.

However, when an audio environment including multiple channels is established using a related user terminal, a user is not able to confirm whether the multi-channel audio environment is established appropriately because no feedback is provided from a speaker. For example, in an environment in which there are a plurality of speakers, the user may not identify an audio channel that is output from a specific speaker. In addition, in the environment in which there are a plurality of speakers, the user may not control the settings of a plurality of channels at once, and has to control the setting of each speaker one at a time, which is inconvenient to the user.

### SUMMARY

Exemplary embodiments overcome the above disadvantages and other disadvantages not described above. Also, an exemplary embodiment is not required to overcome the disadvantages described above, and an exemplary embodiment of the present inventive concept may not overcome any of the problems described above.

One or more exemplary embodiments provide a user terminal device which allows a user to establish a multi-channel audio system more easily and accurately using a plurality of speakers in which a speaker outputs an indicator that indicates that a multi-channel audio environment is set. In addition to the user terminal device, also provided is an example of an audio system, and a method of controlling a speaker thereof.

According to an aspect of an exemplary embodiment, there is provided a method of controlling a speaker of a user terminal device, the method including performing a pairing operation with a plurality of speakers, displaying a multi-channel setting user interface (UI) that comprises identifiers of the plurality of speakers, and in response to a multi-channel setting command for at least two speakers from among the plurality of speakers being input through the multi-channel setting UI, transmitting a multi-channel setting command to the at least two speakers.

The pairing operation may include, in response to the user terminal being placed in contact with one of the plurality of speakers, transmitting network information to the contacted speaker using Near Field Communication (NFC), and performing the pairing operation with the contacted speaker using the network information.

The pairing operation may include, in response to a button on one of the plurality of speakers being selected and a network information request signal being received from the speaker, performing the pairing operation with the speaker by transmitting network information to the speaker.

The pairing operation may further include transmitting a pairing completion signal to the plurality of speakers to indicate that pairing is completed with the plurality of speakers.

The method may further include changing a name of a speaker from among the plurality of speakers represented in the multi-channel setting UI according to a user input.

The multi-channel setting UI may include a plurality of speaker icons corresponding to the plurality of speakers and a plurality of channel icons corresponding to the multiple channels, and the transmitting may include, in response to a user command to drag and drop a first speaker icon onto a first channel icon, transmitting a multi-channel setting command to a first speaker corresponding to the first speaker icon to designate a first audio channel corresponding to the first channel icon to the first speaker.

The method may further include controlling the first speaker to output an indicator indicating that the first speaker is set as a first audio channel.

The method may further include, in response to receiving a multi-touch command selecting two speaker icons corresponding to two speakers, transmitting an audio setting change command to the two speakers corresponding to the selected two speaker icons.

The multi-channel setting UI may include a graphical user interface (GUI) in a form of bar for changing an audio setting of at least two speakers which are set as the multiple channels, and the method may further include, in response to a user command to change an audio setting being received through the GUI, transmitting an audio setting change command to the at least two speakers.

The multi-channel setting UI may include a plurality of source icons corresponding to a plurality of source apparatuses which provide an audio source, and the method may further include, in response to a first source icon being selected, transmitting speaker setting information to a first source apparatus corresponding to the first source icon.

According to an aspect of another exemplary embodiment, there is provided a user terminal device including a communication unit configured to perform a pairing operation with a plurality of speakers, a display configured to display a multi-channel setting user interface (UI) including identifiers of the plurality of speakers, an input unit configured to receive a user command, and a controller configured to, in response to a multi-channel setting command for at least two speakers being input through the multi-channel setting UI, control the communication unit to generate a multi-channel setting command for the at least two speakers and transmit the multi-channel setting command to the at least two speakers.

The communication unit may be NFC interface, and the controller, in response to the user terminal being placed in contact with one of the plurality of speakers, may transmit network information to the contacted speaker using Near Field Communication (NFC), and perform the pairing operation with the contacted speaker using the network information.

The controller, in response to a button on one of the plurality of speakers being selected and a network information request signal being received from the speaker, may perform the pairing operation with the speaker by transmitting network information to the speaker.

The controller may control the communication unit to transmit a pairing completion signal to the plurality of speakers indicating that pairing is completed.

The controller may change a name of a speaker from among the plurality of speakers represented in the multi-channel setting UI according to a user input which is input through the input unit.

The multi-channel setting UI may include a plurality of speaker icons corresponding to the plurality of speakers and a plurality of channel icons corresponding to multi channels, and the controller, in response to a user command to drag and drop a first speaker icon onto a first channel icon, may control the communication unit to transmit a multi-channel setting command to a first speaker corresponding to the first speaker icon to designate a first audio channel corresponding to the first channel icon to the first speaker.

The controller may control the first speaker to output an indicator indicating that the first speaker is set as a first audio channel.

The controller, in response to a multi-touch command selecting two speaker icons corresponding to two speakers being input, may control the communication unit to transmit an audio setting change command to the two speakers corresponding to the selected two speaker icons.

The multi-channel setting UI may include a graphical user interface (GUI) in a form of bar for changing an audio setting of at least two speakers which are set as the multiple channels, and the controller, in response to a user command to change an audio setting through the GUI being input, may control the communication unit to transmit an audio setting change command to the at least two speakers.

The multi-channel setting UI may include a plurality of source icons corresponding to a plurality of source apparatuses which provide an audio source, and the controller, in response to a first source icon being selected, may control the communication unit to transmit speaker setting information to a first source apparatus corresponding to the first source icon.

According to an aspect of another exemplary embodiment, there is provided a method of controlling a speaker of an audio system through a user terminal device, the method including performing a pairing operation with a plurality of speakers, displaying a multi-channel setting user interface (UI) including identifiers of the plurality of speakers, in response to a multi-channel setting command for at least two speakers from among the plurality of speakers being input through the multi-channel setting UI, transmitting a multi-channel setting command to the at least two speakers.

According to an aspect of another exemplary embodiment, there is provided a speaker including a receiver configured to receive data from a user terminal for pairing the speaker with the user terminal, and to receive a multi-channel setting command from the user terminal, the multi-channel setting command identifying a channel for the speaker and identifying another channel for another speaker, a controller configured to set the speaker to the channel included in the multi-channel setting command, and an outputter configured to output a notification indicating that the speaker is set to the channel included in the multi-channel setting command.

The outputter may be configured to output a light indicating that the speaker is set to the channel included in the multi-channel setting command.

The outputter may be configured to output an audio signal indicating that the speaker is set to the channel included in the multi-channel setting command.

### BRIEF DESCRIPTION OF THE DRAWINGS

The above and/or other aspects will be more apparent by describing certain exemplary embodiments with reference to the accompanying drawings, in which:

FIG. 1 is a diagram illustrating a multi-channel audio system according to an exemplary embodiment;

FIG. 2 is a block diagram illustrating a user terminal device according to an exemplary embodiment;

FIG. 3 is a block diagram illustrating a user terminal device according to another exemplary embodiment;

FIGS. 4A, 4B, 5A, 5B, 5C, 5D, 6A, 6B, 6C, 7A, 7B, 8A and 8B are diagrams illustrating a multi-channel setting user interface (UI) according to various exemplary embodiments;

FIG. 9 is a flowchart illustrating a method of controlling a speaker of a user terminal device according to an exemplary embodiment;

FIG. 10 is a diagram illustrating a sequence of controlling a speaker of an audio system according to an exemplary embodiment; and

FIG. 11 is a block diagram illustrating a speaker 1100 according to an exemplary embodiment.

### DETAILED DESCRIPTION

Hereinafter, exemplary embodiments will be described in detail with reference to accompanying drawings. In the following description, same reference numerals are used for analogous elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail because they would obscure the exemplary embodiments with unnecessary detail.

In the following disclosure, relational terms such as first and second, and the like, may be used to distinguish one entity from another entity, without necessarily implying any actual relationship or order between such entities.

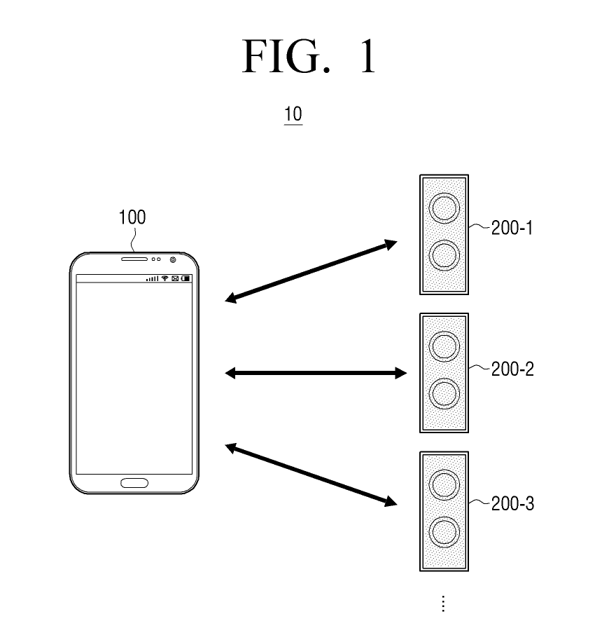

FIG. 1 is a diagram illustrating a multi-channel audio system according to an exemplary embodiment. As illustrated in FIG. 1, multi-channel audio system 10 includes a user terminal device 100 and a plurality of speakers 200-1, 200-2, 200-3, etc. In this example, the user terminal device 100 is a smart phone, but this is only an example. As another example, the user terminal device 100 may be various electronic apparatuses such as a tablet personal computer (PC), a notebook PC, a desktop PC, a smart TV, an appliance, and the like. The plurality of speakers 200-1, 200-2, 200-3, . . . may be located throughout various areas of a house, an office, a room, and the like. For example, the first speaker 200-1 and the second speaker 200-2 may be located in a living room, and the third speaker 200-3 may be located in a bedroom.

According to various aspects, the user terminal device 100 may pair with each of the plurality of speakers 200-1, 200-2, 200-3, . . . . In this example, the user terminal device 100 may pair with the plurality of speakers 200-1, 200-2, 200-3, . . . using various communication methods such as Near Field Communication (NFC), WiFi communication, Bluetooth communication, and the like. The pairing directly between the user terminal device 100 and the plurality of speakers 200-1, 200-2, 200-3, . . . is only an example. As another example, the user terminal device 100 may pair with the plurality of speakers 200-1, 200-2, 200-3, . . . via a hub (not shown) which is connected to a network such as a WiFi network.

When the pairing is completed, the user terminal device 100 may transmit a pairing completion signal to the plurality of speakers 200-1, 200-2, 200-3, . . . . In response, each of the plurality of speakers 200-1, 200-2, 200-3, . . . may output an indicator indicating that the pairing is finished. For example, light emitting diodes (LEDs) included in the plurality of speakers 200-1, 200-2, 200-3, . . . may blink, an audio message such as “pairing is completed” may be output, and the like.

When the pairing is performed, the user terminal device 100 may display a multi-channel setting user interface (UI) identifying the plurality of speakers 200-1, 200-2, 200-3, . . . . For example, the multi-channel setting UI may include identifiers such as a plurality of speaker icons corresponding to the plurality of speakers 200-1, 200-2, 200-3, . . . and a plurality of channel icons corresponding to multiple channels. Names of the plurality of speakers represented by the multi-channel setting UI may vary according to a user input. For example, a user may change the name of an identifier of a speaker from “kitchen speaker” to “bedroom speaker.”

In response to a multi-channel setting command with respect to at least two speakers from among the plurality of speakers 200-1, 200-2, 200-3 being input through the multi-channel setting UI, the user terminal device 100 may transmit the multi-channel setting command to the at least two speakers. For example, a user command may drag and drop the first speaker icon included in the multi-channel setting UI towards the first channel icon. In response, the user terminal device 100 may recognize the user command to designate the first channel to the first speaker 200-1 and transmit the multi-channel setting command to set the first speaker 200-1 corresponding to the first speaker icon to designate the first audio channel (for example, a left channel) corresponding to the first channel icon to the first speaker 200-1.

Similarly, the user terminal device 100 may transmit the multi-channel setting command to a second speaker 200-2 corresponding to a second speaker icon to designate a second audio channel (for example, a right channel) corresponding to the second channel icon as the second speaker 200-2. For example, the user terminal device 100 may transmit the multi-channel setting command to the first and second speakers 200-1 and 200-2 at once. For example, the multi-channel setting command may be transmitted simultaneously to the first and second speakers 200-1 and 200-2. As another example, the user terminal device 100 may transmit the multi-channel setting command to the first speaker 200-1 and then to the second speaker 200-2, or vice versa.

If the multi-channel setting command is received, the two speakers set as the multi-channel may output an indicator indicating that the multi-channel is set. For example, the first speaker 200-1 may receive a left channel setting command. Accordingly, the first speaker 200-1 may output an indicator indicating that the first speaker 200-1 is set as the left channel. As an example, the first speaker 200-1 may cause an LED included therein to blink, or may output an audio message such as “the speaker is set as a left channel.”

The user terminal device 100 may output an audio setting change command with respect to the at least two speakers which are set as the multi-channel according to a user input. For example, a multi-touch command may be used to simultaneously select two icons from among speaker icons corresponding to the at least two speakers. Next, a user command to change the audio setting may be input. As a result, the user terminal device 100 may transmit the audio setting change command to the two speakers corresponding to the selected two speaker icons. The multi-channel setting UI may include a GUI in the form of bar for changing audio setting of the at least two speakers which are set as the multi-channel. Accordingly, if a user command to change the audio setting is input through the GUI, the user terminal device 100 may transmit the audio setting change command to the at least two speakers. The two speakers may change the audio setting in accordance with the received audio setting change command, and may also output a test audio.

In addition, the multi-channel setting UI may include a plurality of source icons corresponding to a plurality of source apparatuses (not shown) which are capable of being an audio source. For example, the source apparatus may be a device capable of playing content and/or audio such as a television, a smart phone, a computer, a tablet, a gaming console, a set-top box, a stereo, and the like. If the first source icon is selected from among the plurality of source icons displayed on the UI, the user terminal device 100 may transmit speaker setting information to the first source apparatus corresponding to the first source icon. In this example, the first source apparatus may transmit an audio source to the at least two speakers which are set as the multi-channel based on the speaker setting information.

As described above, using the multi-channel audio system 10, a user may establish a multi-channel audio environment more conveniently and accurately using a user terminal device.

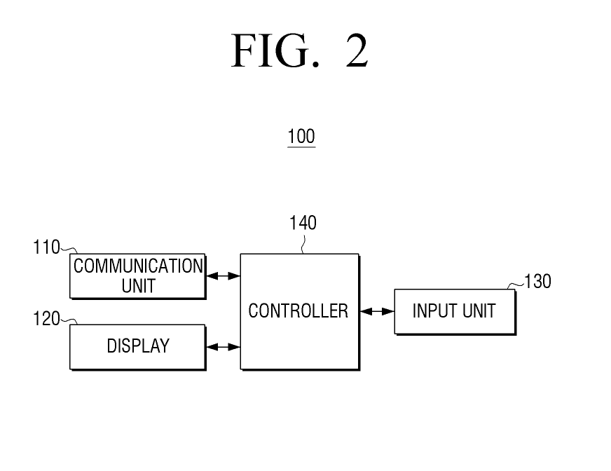

FIG. 2 is a block diagram illustrating a user terminal device 100 according to an exemplary embodiment. As illustrated in FIG. 2, the user terminal device 100 includes a communication unit 110, a display 120, an input unit 130, and a controller 140.

The communication unit 110 may communicate with an external speaker 200 to pair with the speaker 200. For example, the communication unit 110 may pair with the external speaker 200 using at least one of a near field communication (NFC) interface, a Bluetooth interface, a WiFi interface, a Zigbee interface, and the like.

The display 120 displays image data and various user interfaces (UIs) under the control of the controller 140. For example, the display 120 may display a multi-channel setting UI to establish a multi-channel audio environment using a plurality of external speakers 200-1, 200-2, 200-3, . . . .

The input unit 130 may receive a user command to control the user terminal device 100. For example, the input unit 130 may include a touch panel, a keypad, a joystick, and the like for receiving a user's touch command. As another example, the input unit 130 may include a microphone to receive vocal commands. As another example, the input unit may include a camera or other sensor to sense and receive user commands by hand motion and the like.

The controller 140 may control the overall operations of the user terminal device 100 according to the user command input through the input unit 130. In response to receiving a multi-channel setting command with respect to at least two speakers through the UI, the controller 140 may control the communication unit 110 to generate a multi-channel setting command with respect to the at least two speakers and transmit the multi-channel setting command to the at least two speakers. In response to being set, the at least two speakers may output an indicator indicating that the multi-channel is set in response to the multi-channel setting command.

The controller 140 may control the pairing with the external speaker 200 through the communication unit 110. In an example in which the communication unit 110 includes the NFC interface, and the user terminal device 100 may touch or otherwise make contact with one of the plurality of speakers 200-1, 200-2, 200-3, . . . , and the controller 140 may transmit network information to the speaker using the NFC interface thereby pairing the speaker with the user device using the network information. For example, download information about an application to establish a multi-channel audio environment may be received at the speaker using the NFC interface, and the controller 140 may download and install the application to establish a multi-channel audio environment.

As another example, a button on the first speaker 200-1 from among the plurality of speakers 200-1, 200-2, 200-3, . . . may be selected, and a network information request signal may be transmitted from the first speaker 200-1 and received by the communication unit 100. Accordingly, the controller 140 may pair with the first speaker 200-1 by transmitting the network information to the first speaker 200-1 in response to the network information request signal.

As another example, the controller 140 may perform the pairing operation with the external speaker 200 through a hub which is connected to, for example, a WiFi network.

When pairing is completed, the controller 140 may control the communication unit 110 to transmit a pairing completion signal to the plurality of speakers. In response, the speaker 200 may output a pairing indicator indicating that pairing is complete. For example, the speaker may blink an LED or output an audio message, “pairing is completed” as the pairing indicator.

If pairing with a plurality of speakers is completed, the controller 140 may control the display 120 to display a multi-channel setting UI including identifiers of the plurality of speakers. For example, the multi-channel setting UI may include a plurality of speaker icons corresponding to the plurality of speakers and a plurality of channel icons corresponding to a plurality of channels. While the multi-channel setting UI is displayed, the controller 140 may change the name of a speaker icon included in the multi-channel setting UI according to a user command input through the input unit 130.

In response to a predetermined user command being input using the multi-channel setting UI, the controller 140 may control the communication unit 110 to transmit a multi-channel setting command to at least two speakers from among the plurality of speakers. For example, the controller 140 may set the channel of the speakers according to the user's drag-and-drop command input through the input unit 130. If a user drags the first speaker icon towards the first channel icon and drops it on the first channel icon using the input unit 130, the controller 140 may control the communication unit 110 to transmit the multi-channel setting command to set the first audio channel corresponding to the first channel icon, to the first speaker corresponding to the first speaker icon. In response, the first speaker may output a channel setting indicator indicating that the first speaker is set as the first audio channel. For example, the first speaker may blink a particular LED or output an audio message, “the speaker is set as a left channel”, as the channel setting indicator.

If an audio setting change command is input while the multi-channel setting UI is displayed, the controller 140 may control the communication unit 110 to transmit the audio setting change command to the speaker to set the speaker as part of the multi-channel.

As another example, a multi-touch command of touching two speaker icons at the same time may be input through the input unit 130, and the controller 140 may control the communication unit 110 to transmit the audio setting change command to the two speakers corresponding to the selected two speaker icons. The multi-channel setting UI may include a GUI in the form of bar for changing the audio setting of the at least two speakers which are set as the multi-channel. A user command to change the audio setting may be input through the GUI in the form of bar, and the controller 140 may control the communication unit 110 to transmit the audio setting change command to the at least two speakers.

The controller 140 may control the communication unit 110 to select a source apparatus as an audio source and transmit speaker setting information to the selected source apparatus using the multi-channel setting UI. In an example in which the multi-channel setting UI includes a plurality of source icons corresponding to a plurality of source apparatuses, and the first source icon from among the plurality of source icons is selected through the input unit 130, the controller 140 may control the communication unit 110 to transmit the speaker setting information to the first source apparatus corresponding to the first source icon. In this example, the first source apparatus may transmit an audio source to a plurality of speakers based on the speaker setting information. As another example, the controller 140 may control the communication unit 110 to transmit an audio source stored in the user terminal device 100 directly to a plurality of speakers. Accordingly, a content production device such as a television, a smart phone, a computer, a tablet, a gaming console, a set-top box, a stereo, and the like, may produce content to the output by at least two speakers. As another example, the user terminal device 100 itself may output content to the speakers.

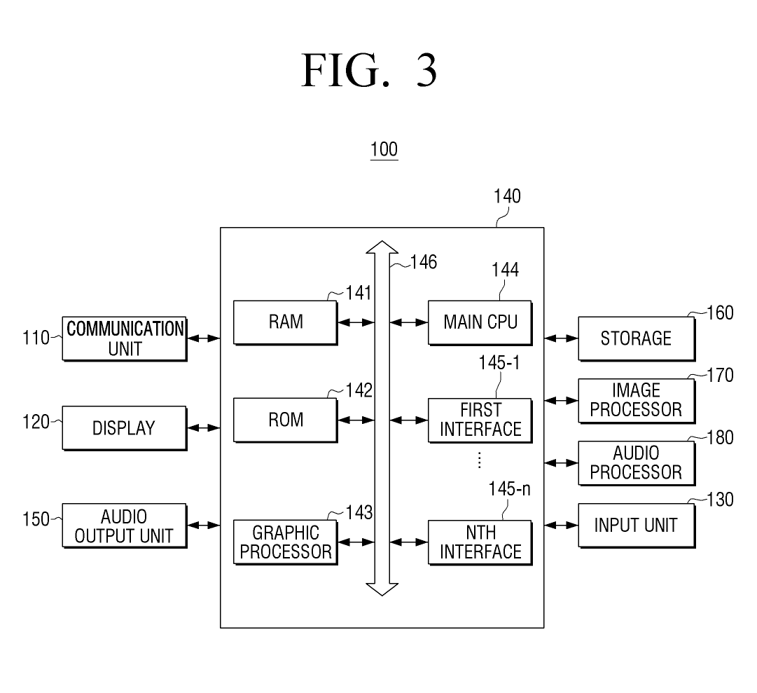

FIG. 3 is a block diagram illustrating the user terminal device 100 according to another exemplary embodiment. As illustrated in FIG. 3, the user terminal device 100 includes the communication unit 110, the display 120, an audio output unit 150, a storage 160, an image processor 170, an audio processor 180, the input unit 130, and the controller 140.

Each element of FIG. 3 is illustrated in a comprehensive manner and it is assumed that the user terminal device 100 is an apparatus with various functions such as a communication function, an image receiving function, a display function, and the like. However, depending on an exemplary embodiment, it should be appreciated that some elements illustrated in FIG. 3 may be omitted or changed, some other elements may be added, or some elements may be combined. Also some functions and constructions may be omitted.

The communication unit 110 may communicate with various types of external apparatuses or external servers according to various types of communication methods. For example, the communication unit 110 may include various communication interfaces such as a WiFi interface, a Bluetooth interface, a NFC interface, a wireless communication interface, and the like. In this case, the Wifi interface, the Bluetooth interface, and the NFC interface communicate according to a WiFi method, a Bluetooth method, and a NFC method, respectively. The NFC interface operates according to an NFC method which may use a 13.56 MHz band among various RF-ID frequency bands such as 135 kHz, 13.56 MHz, 433 MHz, 860-960 MHz, 2.45 GHz, and the like. In the case of the WiFi interface or the Bluetooth interface, various connection information such as a SSID and a session key may be transmitted/received prior to a communication connection being established, and various information may be transmitted/received using the same. The wireless communication interface may communicate according to various communication standards such as Institute of Electrical and Electronics Engineers (IEEE), Zigbee, 3^{rd} Generation (3G), 3^{rd} Generation Partnership Project (3GPP), Long Term Evolution (LTE), and the like.

In an example in which the communication unit 110 includes the NFC interface, and the user terminal device 100 may be placed in contact with the speaker 200, and the communication unit 110 may receive application download information through the NFC interface and transmit network information for pairing with the speaker. In an example in which the communication unit 110 is a Bluetooth interface or a WiFi interface, a button on the outside of the speaker 200 may be selected by a user. Accordingly, the speaker may transmit a network information request from the speaker 200 to the communication unit 110 through the Bluetooth interface or the WiFi interface. In response, the communication unit 110 may transmit network information for pairing in response to the network information request.

The display 120 may display a video frame which is generated as the image processor 170 processes image data received from the image receiver (not shown). The display may also display various UIs generated by a graphic processor 143. According to various aspects, the display 120 may display a multi-channel setting UI to establish a multi-channel audio environment. The multi-channel setting UI may include speaker icons corresponding to a plurality of speakers, channel icons corresponding to multi channels, and the like.

The audio output unit 150 may output various audio data processed by the audio processor 180 and also various alarm sounds or voice messages.

The storage 160 may store various modules to drive the user terminal device 100. For example, the storage 160 may store software including a base module, a sensing module, a communication module, a presentation module, a web browser module, a service module, and the like. The base module refers to a basic module which processes a signal transmitted from hardware included in the user terminal device 100, and transmits the processed signal to an upper layer module. The sensing module collects information from various sensors, and analyzes and manages the collected information. For example, the sensing module may include a face recognition module, a voice recognition module, a motion recognition module, an NFC recognition module, and the like. The presentation module is a module to compose a display screen. The presentation module may include a multimedia module for reproducing and outputting multimedia contents, and a UI rendering module for UI and graphic processing. The communication module may communicate with other devices. The web browser module refers to a module which accesses a web server to perform web-browsing. The service module is a module including various applications for providing various services. The storage 160 may also store an application to establish a multi-channel audio environment using the plurality of external speakers 200-1, 200-2, 200-3, . . . .

The image processor 170 processes image data received from the image receiver. For example, the image processor 170 may perform various image processing with respect to image data, such as decoding, scaling, noise filtering, frame rate conversion, resolution conversion, and the like.

The audio processor 180 processes audio data. For example, the audio processor 180 may perform various processing with respect to audio data, such as decoding, amplification, noise filtering, and the like. The audio data processed by the audio processor 180 may be output to the audio output unit 150.

The input unit 130 receives commands to control overall operations of the user terminal device 100. For example, the input unit 130 may include a touch panel to receive touch commands from a user. As another example, the input unit 130 may include various input apparatuses such as a pointing device, a motion recognition apparatus, a mouse, a voice recognition apparatus, and the like.

The controller 140 controls overall operations of the user terminal device 100 using various programs stored in the storage 160.

As illustrated in FIG. 3, the controller 140 includes a random-access memory (RAM) 141, a read-only memory (ROM) 142, a graphic processor 143, a main central processing unit (CPU) 144, a first to nth interface 145-1˜145-n, and a bus 146. In this example, the RAM 141, the ROM 142, the graphic processor 143, the main CPU 144, and the first to the nth interface 145-1˜145-n are interconnected through the bus 146.

The ROM 142 stores a set of commands for system booting. If a turn-on command is input and power is supplied, the main CPU 144 may copy an operating system stored in the storage 160 into the RAM 141 according to a command stored in the ROM 142, and boot a system by executing the operating system. Once the booting is completed, the main CPU 144 may copy various application programs stored in the storage 160 into the RAM 141, and perform various operations by executing the application programs copied in the RAM 141.

The graphic processor 143 may generate a screen including various objects such as an icon, an image, a text, and the like, using an operation unit (not shown) and a rendering unit (not shown). The operation unit may compute property values such as coordinates, a shape, a size, and a color of the objects to be displayed according to the layout of a screen using a control command received from the input unit 130. The rendering unit may generate screens of various layouts including objects based on the property values computed by the operation unit. The screens generated by the rendering unit are displayed in a display area of the display 120.

The main CPU 144 accesses the storage 160 and may perform booting using the operating system stored in the storage 160. In addition, the main CPU 144 performs various operations using various programs, contents, data, etc. stored in the storage 160.

The first to the nth interfaces 145-1 to 145-n are connected to the above-described various components. At least one of the interfaces may be a network interface which is connected to an external apparatus via a network.

The controller 140 may perform the pairing operation with the plurality of external speakers 200-1, 200-2, 200-3, . . . using various communication interfaces. As one example, the controller 140 may pair with the plurality of external speakers 200-1, 200-2, 200-3, . . . through the NFC interface. In this example, when the user terminal device 100 is in contact with the speaker 200, the controller 140 may transmit network information for pairing to the external speaker 200 through the NFC interface. The speaker 200 may then pair with the user terminal device 100 using the network information.

As another example, the controller 140 may perform the pairing operation using a WiFi Protect Setup (WPS) button. If the WPS button on the speaker 200 is selected, the speaker 200 may transmit a network information request signal to the user terminal device 100. The user terminal device 100 may transmit network information for pairing to the user terminal device in response to the network information request signal. The speaker 200 may then pair with the user terminal device 100 using the network information.

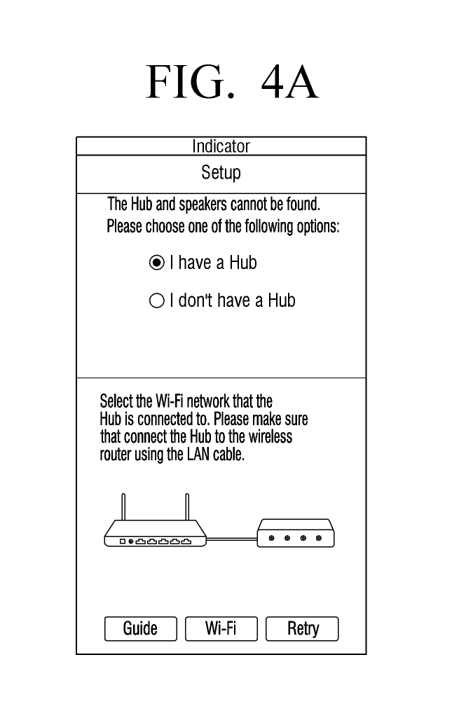

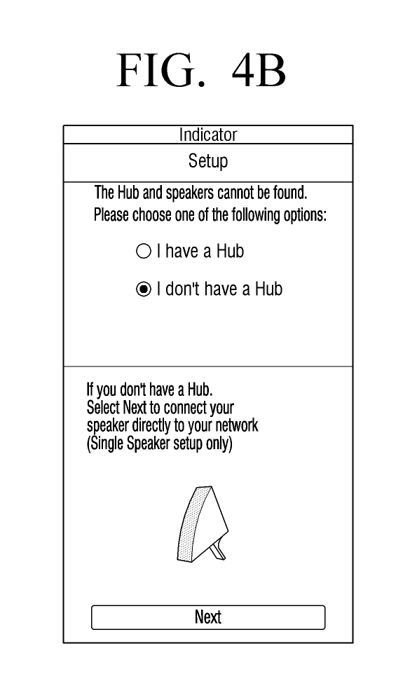

FIGS. 4A through 8B are diagrams illustrating a multi-channel setting user interface (UI) according to various exemplary embodiments.

For example, if the user terminal device 100 is connected to a hub which is connected to a WiFi network, the controller 140 may perform the pairing operation with the speaker 200 using a UI as illustrated in FIG. 4A. Alternatively, if the user terminal device 100 is not connected to a hub, the controller 140 may perform the pairing operation with the speaker 200 using a UI as illustrated in FIG. 4B. In this case, the controller 140 may perform pairing with the speaker 200 as a user directly inputs information to the speaker 200.

When the pairing is completed, the controller 140 may control the communication unit 110 to transmit a pairing completion signal to the speaker 200. In response to receiving the pairing completion signal, the speaker 200 may output an indicator indicating that the pairing is completed in various ways. For example, the speaker 200 may blink an LED at a predetermined interval, or output an audio message such as “pairing is completed.” Accordingly, a user may acknowledge that the pairing is completed through the indicator output by the speaker 200.

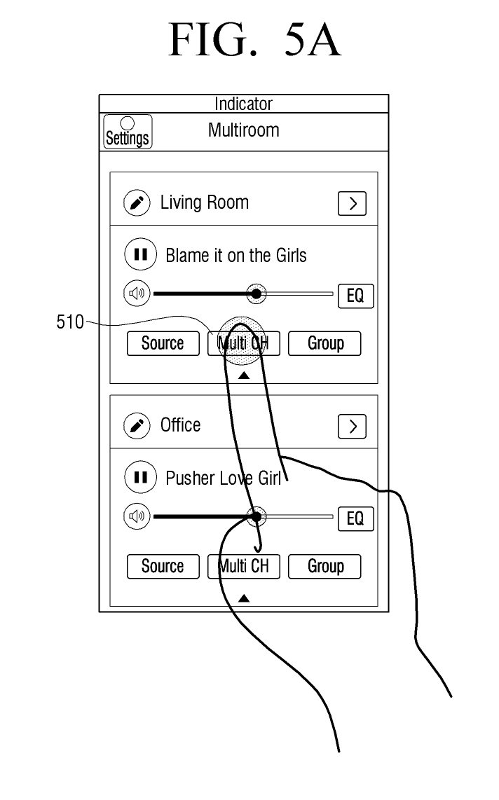

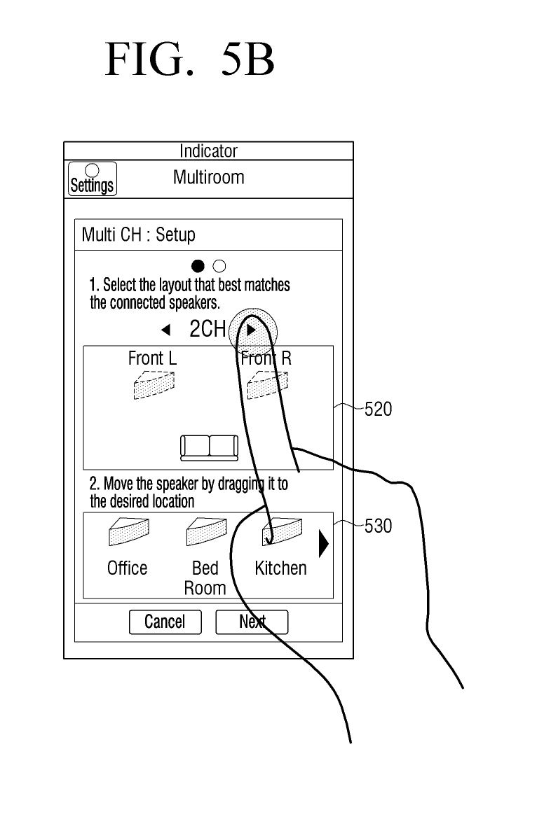

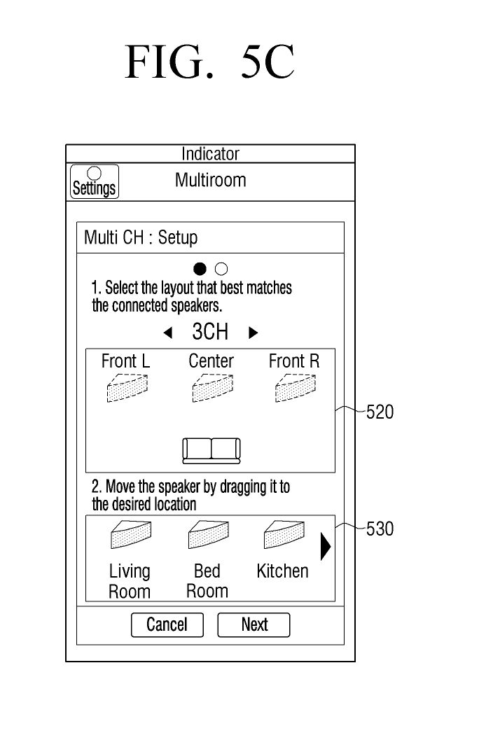

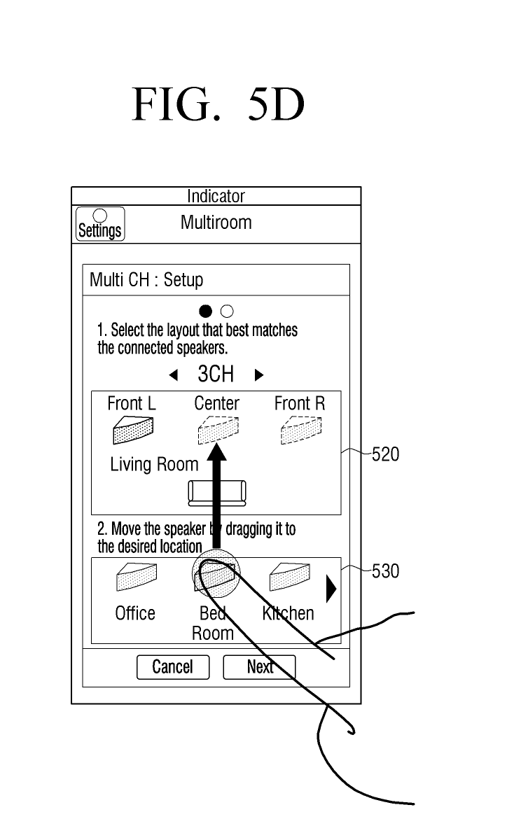

The controller 140 may control the display 120 to display a multi-channel setting UI including a plurality of speakers for which pairing may be performed. Referring to FIG. 5A, an icon 510 for multi-channel setting is selected while an application to establish a multi-channel audio environment is being executed. Accordingly, the controller 140 may control the display 120 to display a multi-channel setting UI as illustrated in FIG. 5B. In this example, the multi-channel setting UI includes a channel icon area 520 including channel icons corresponding to multi channels and a speaker icon area 530 including speaker icons corresponding to a plurality of speakers.

In addition, the controller 140 may set the number of channels to be established according to a user command input through the input unit 130. For example, if an audio environment with three channels is desired, a user may touch the toggle button “ [symbol] ” as illustrated in FIG. 5B, and the controller 140 may control the display 120 to display a multi-channel setting UI and increase the two-channel option to a three-channel audio environment as illustrated in FIG. 5C.

The controller 140 may set a speaker corresponding to multi channels through a drag-and-drop operation performed by a user, and control the communication unit 110 to transmit a multi-channel setting command to the speaker 200. As illustrated in FIG. 5D, a user touches and drags a “Bed Room” icon and drops the icon on the center channel icon. In response, the controller 140 may set a “Bed Room” speaker corresponding to Bed Room” icon as a center channel, and control the communication unit 110 to transmit a center channel setting command to the “Bed Room” speaker. Accordingly, the controller 140 may establish a three-channel audio environment using three speakers from among a plurality of speakers.

The speaker 200 may receive the multi-channel setting command and output a channel setting indicator indicating that multi channels are set in response to the multi-channel setting command. In this example, the speaker 200 may blink an LED at predetermined intervals, or output an audio message such as “center channel is set”. Accordingly, a user may be notified that a channel is set and channel information through the channel setting indicator output from the speaker 200.

As another example, the controller 140 may change the setting of at least two speakers which are set as the multi channels according to a user command input through the input unit 130, and control the communication unit 110 to transmit an audio setting change command to the at least two speakers. For example, a user may select two icons from among speaker icons corresponding to at least two speakers through the input unit 130, and the controller 140 may control the communication unit 110 to transmit an audio setting change command to two speakers corresponding to the selected speaker icons.

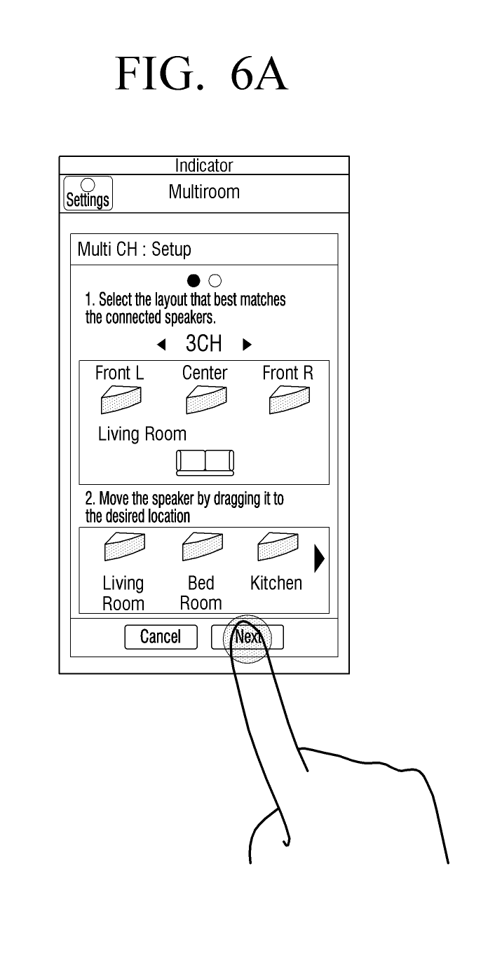

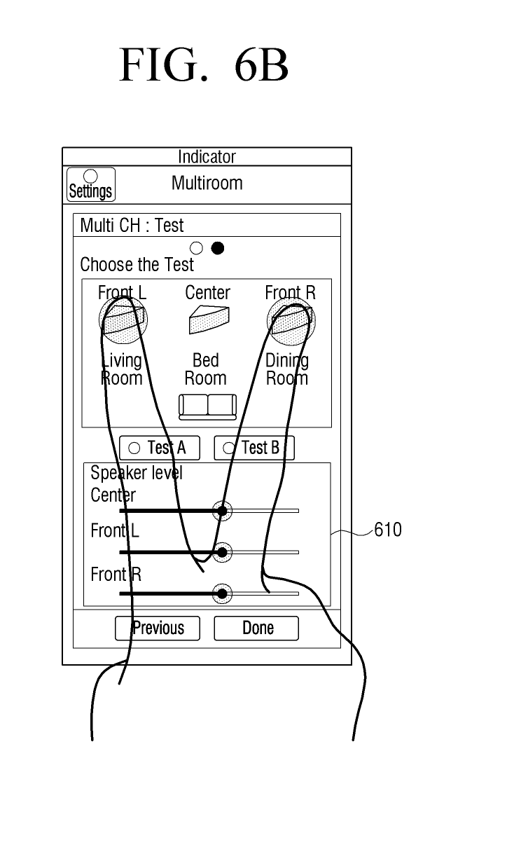

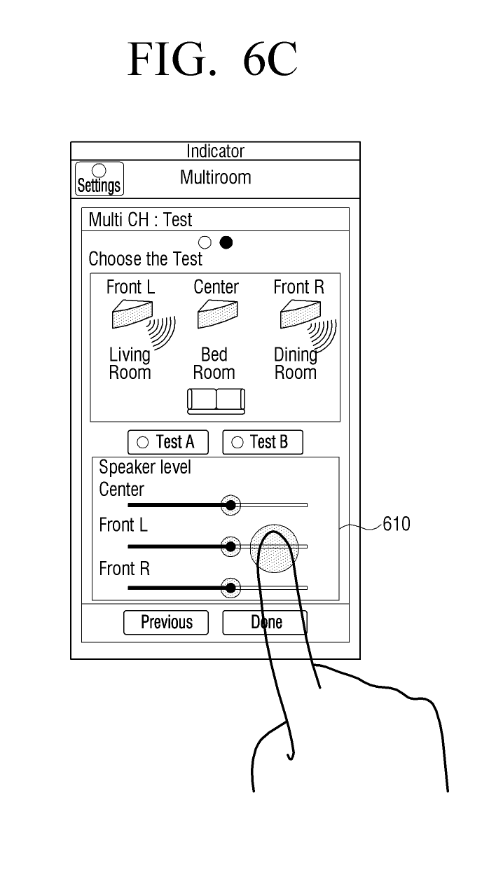

Referring to FIG. 6A, if a “Next” icon is selected while a multi-channel setting UI is displayed, the controller 140 may control the display 120 to display a multi-channel setting UI as illustrated in FIG. 6B. In this example, the multi-channel setting UI includes a GUI 610 in the form of bar for changing the audio setting of the at least two speakers, as illustrated in FIG. 6B. Here, two speakers (for example, “Living Room” icon and “Dining Room” icon) are simultaneously touched from among a plurality of speakers which are set as the multi touch as illustrated in FIG. 6B, and a user touch to increase the volume level of a front-left channel may be input using the GUI in the form of bar. In response, the controller 140 may control the communication unit 110 to transmit an audio setting change command to “Living Room” speaker and “Dining Room” speaker. The “Living Room” speaker may output a test audio at the changed volume level in response to the audio setting change command, and the “Dining Room” speaker may output a test audio in one volume level in response to the audio setting change command. Accordingly, by listening to a test audio using a multi touch, a user may change the audio setting of multiple channels more conveniently.

As another example, the controller 140 may set a source apparatus which provides an audio source according to a user command input through the input unit 130, and control the communication unit 110 to transmit speaker setting information to the set source apparatus. For example, the source apparatus may be another device such as a television, a smart phone, a computer, a tablet, a gaming console, a set-top box, a stereo, and the like.

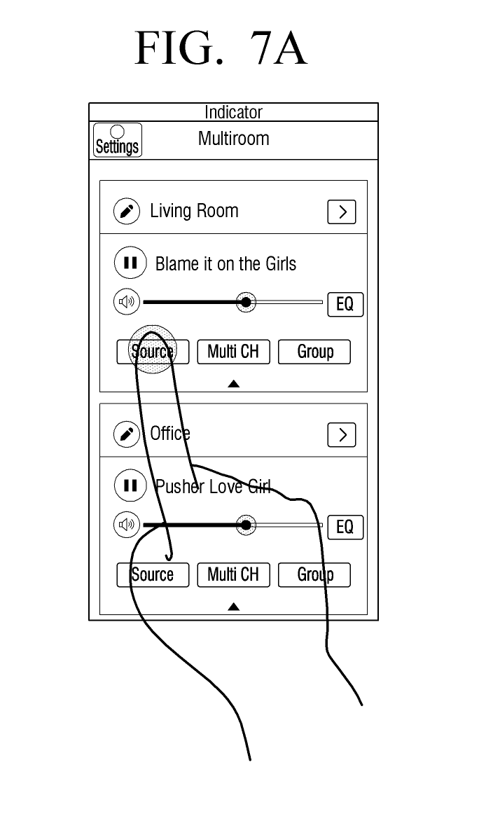

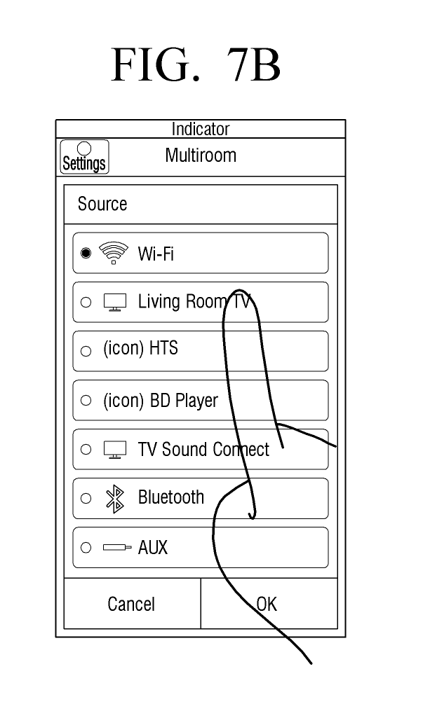

For example, if a “Source” icon is touched while a multi-channel setting UI is displayed as illustrated in FIG. 7A, the controller 140 may control the display 120 to display a multi-channel setting UI as illustrated in FIG. 7B. In this example, the multi-channel setting UI includes a plurality of source icons corresponding to a plurality of source apparatuses which provide an audio source as illustrated in FIG. 7B. If the first source icon is touched through the input unit 130, the controller 140 controls the communication unit 110 to transmit speaker setting information to the first source apparatus corresponding to the first source icon. For example, if a “Living Room TV” icon is touched, the controller 140 may control the communication unit 110 to transmit speaker setting information of a multi-channel audio environment to a living room television corresponding to “Living Room TV” icon. The speaker setting information may include network information, multi-channel setting information, and the like.

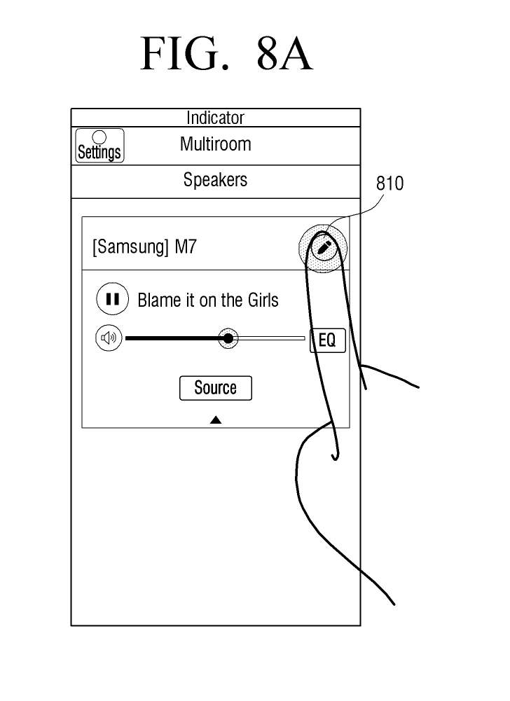

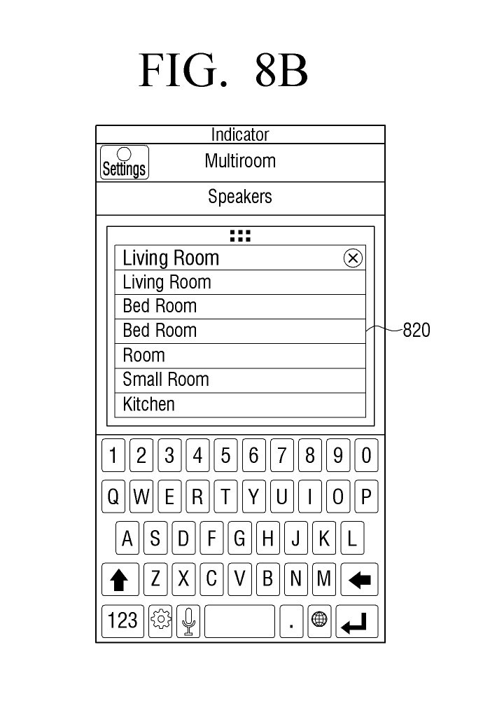

In addition, the controller 140 may change the names of a plurality of speakers included in the multi-channel setting UI according to a user input. Referring to FIG. 8A, an icon 810 is selected from the UI for changing the setting of a speaker. Accordingly, the controller 140 may control the display 120 to display a UI 820 for changing the names of speakers as illustrated in FIG. 8B. In this example, the UI may display a list of room names and a text input window in which a user may directly input a text as illustrated in FIG. 8B. The user may change the names of speakers to room names or other desired names through the UI for changing the names of speakers.

As described above, by using the user terminal device 100, a user may simultaneously establish a multi-channel audio environment more conveniently and accurately.

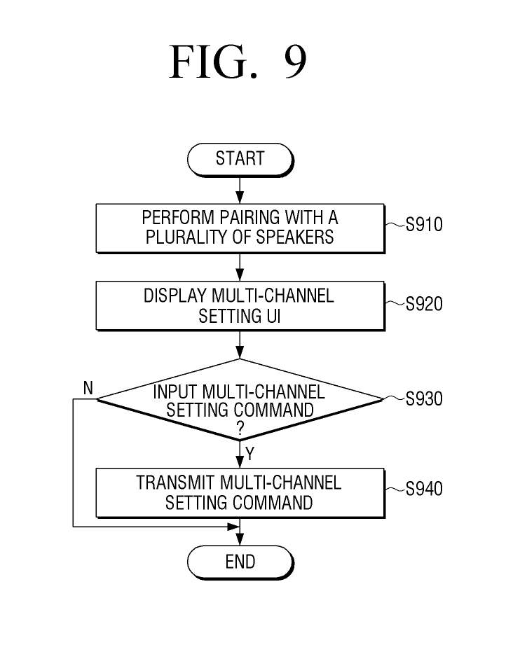

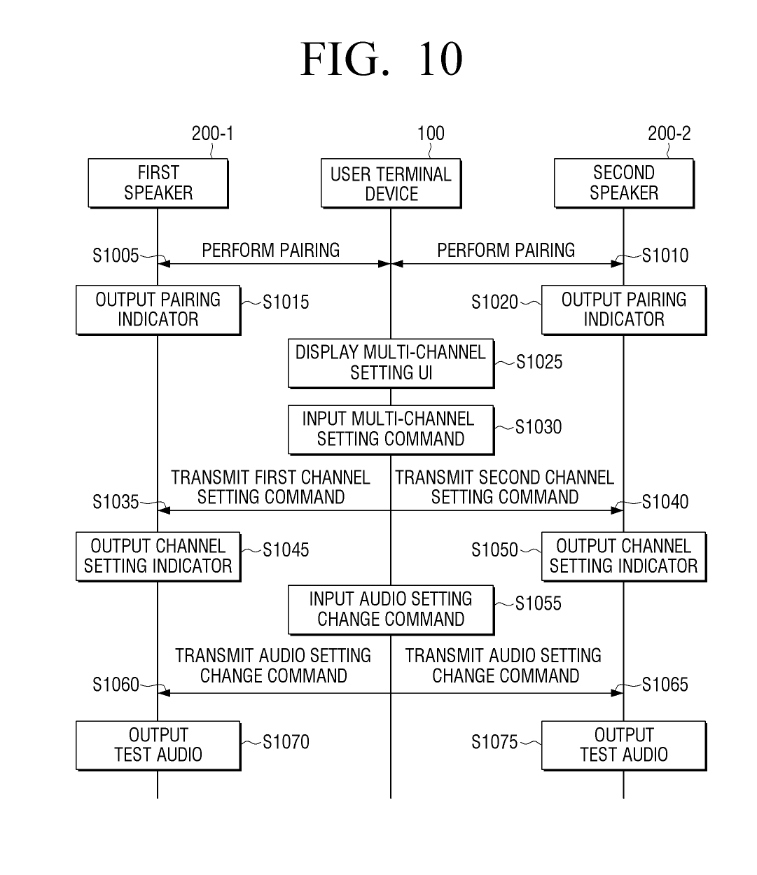

Hereinafter, the method of controlling a speaker is described with reference to FIGS. 9 and 10. FIG. 9 is a flowchart illustrating a method of controlling a speaker of a user terminal device according to an exemplary embodiment.

Referring to FIG. 9, the user terminal device 100 performs a pairing operation with the plurality of speakers 200-1, 200-2, 200-3, . . . (S910). In this case, the user terminal device 100 may perform pairing with an external speaker through various communication interface such as NFC interface, WiFi interface, Bluetooth interface, and the like.

Subsequently, the user terminal device 100 displays a multi-channel setting UI (S920). The multi-channel setting UI may include a plurality of speaker icons corresponding to a plurality of speakers and a plurality of channel icons corresponding to multi channels.

The user terminal device 100 determines whether a multi-channel setting command is input (S930). For example, the multi-channel setting command may be a drag-and-drop command to drag and drop a speaker icon towards a channel icon.

If the multi-channel setting command is input (S930-Y), the user terminal device 100 transmits the multi-channel setting command to a speaker (S940). The speaker which receives the multi-channel setting command may output an indicator indicating that multiple channels are set. The indicator may be provided in a visual form such as a blinking LED or in a auditory form such as an audio message.

FIG. 10 is a sequence diagram illustrating a method of controlling a speaker of the audio system 10 according to an exemplary embodiment.

The user terminal device 100 pairs with the first speaker 200-1 and the second speaker 200-2 (S1005, S1010). In response, the first speaker 200-1 and the second speaker 200-2 output a pairing indicator, respectively (S1015, S1020). The pairing indicator may be used to indicate that the pairing with the user terminal device 100 is completed.

Subsequently, the user terminal device 100 displays a multi-channel setting UI (S1025), and receives a multi-channel setting command using the multi-channel setting UI (S1030). In response, the user terminal device 100 transmits the first channel setting command to the first speaker 200-1 (S1035), and transmits the second channel setting command to the second speaker 200-2 (S 1040). For example, the user terminal device 100 may simultaneously transmit the first channel setting command and the second channel setting command.

The first speaker 200-1 outputs a channel setting indicator in response to the first channel setting command (S1045), and the second speaker 200-2 outputs a channel setting indicator in response to the second channel setting command (S1050). The channel setting indicator indicates that multiple channels are set.

The user terminal device 100 receives an audio setting change command through the multi-channel setting UI (S1055). As an example, the user terminal device 100 may receive an audio setting change command using a multi touch as illustrated in FIG. 6B. The user terminal device 100 transmits the audio setting change command to the first speaker 200-1 and the second speaker 200-2, respectively (S1060, S1065).

The first speaker 200-1 and the second speaker 200-2 output a test audio in response to the audio setting change command (S1070, S1075). Accordingly, by checking various indicators from a speaker while multi channels are set through the above-described audio system 10, a user may establish a multi-channel audio system more accurately and conveniently.

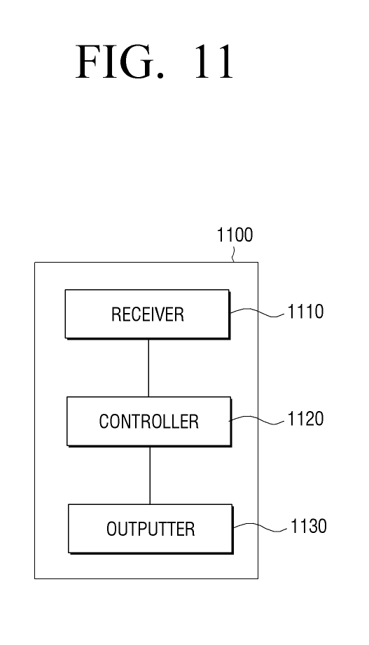

FIG. 11 is a diagram illustrating a speaker 1100 according to an exemplary embodiment. For example, the speaker 1100 may correspond to the speaker 200-1, 200-2, and 200-3 illustrated in FIG. 1.

Referring to FIG. 11, the speaker 1100 includes a receiver 1110, a controller 1120, and an outputter 1130. The receiver 1110 may receive data from an external source such as a user terminal device. The controller 1120 may control the speaker 1100 based on data received from the user terminal device. For example, the controller 1120 may control the speaker 1100 to pair with the user terminal device, to receive a multi-channel setting command from the user device, and set the speaker as an audio source for the user terminal device or for another source apparatus. The outputter 1130 may output a signal indicating that the speaker 1100 is set to the multi-channel setting mode. For example, the outputter 1130 may output a light or an audio signal indicating that the speaker 1100 is set to the multi-channel mode.

Meanwhile, the method of controlling a speaker according to the above-described various exemplary embodiments may be realized as a program and provided in a user terminal device. In addition, a non-transitory computer readable medium storing the program may be provided. The non-transitory recordable medium refers to a medium which may store data semi-permanently rather than storing data for a short time such as a register, a cache, and a memory and may be readable by an apparatus. Specifically, the above-described various applications or programs may be stored in the non-transitory readable medium may be CD, DVD, hard disk, Blu-ray disk, USB, memory card, ROM, and the like, and provided therein.

The foregoing embodiments and advantages are merely exemplary and are not to be construed as limiting the description. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of controlling a speaker with a user terminal device, the method comprising:
performing a pairing operation with a plurality of speakers;
displaying a multi-channel setting user interface (UI) that comprises identifiers of the plurality of speakers; and
in response to a multi-channel setting command for at least two speakers from among the plurality of speakers being input through the multi-channel setting UI, transmitting a multi-channel setting command to the at least two speakers.

2. The method of claim 1, wherein the pairing operation comprises, in response to a user terminal being placed in contact with one of the plurality of speakers, transmitting network information to the contacted speaker using Near Field Communication (NFC), and performing the pairing operation with the contacted speaker using the network information.

3. The method of claim 1, wherein the pairing operation comprises, in response to a button on one of the plurality of speakers being selected and a network information request signal being received from the speaker, performing the pairing operation with the speaker by transmitting network information to the speaker.

4. The method of claim 1, wherein the pairing operation further comprises transmitting a pairing completion signal to the plurality of speakers to indicate that pairing is completed with the plurality of speakers.

5. The method of claim 1, further comprising changing a name of a speaker from among the plurality of speakers represented in the multi-channel setting UI according to a user input.

6. The method of claim 1, wherein the multi-channel setting UI comprises a plurality of speaker icons corresponding to the plurality of speakers and a plurality of channel icons corresponding to multiple channels, and
the transmitting comprises, in response to receiving a user command to drag and drop a first speaker icon on a first channel icon, transmitting a multi-channel setting command to a first speaker corresponding to the first speaker icon to designate a first audio channel corresponding to the first channel icon to the first speaker.

7. The method of claim 1, further comprising controlling a first speaker to output an indicator indicating that the first speaker is set as a first audio channel.

8. The method of claim 6, further comprising in response to receiving a multi-touch command selecting two speaker icons corresponding to two speakers, transmitting an audio setting change command to the two speakers corresponding to the selected two speaker icons.

9. The method of claim 8, wherein the multi-channel setting UI comprises a graphical user interface (GUI) in a form of bar for changing an audio setting of at least two speakers which are set as the multi channels, and
the method further comprises, in response to a user command to change an audio setting being received through the GUI, transmitting an audio setting change command to the at least two speakers.

10. The method of claim 1, wherein the multi-channel setting UI comprises a plurality of source icons corresponding to a plurality of source apparatuses which provide an audio source, and
the method further comprises, in response to a first source icon being selected, transmitting speaker setting information to a first source apparatus corresponding to the first source icon.

11. A user terminal device comprising:
a communication unit configured to perform a pairing operation with a plurality of speakers;
a display configured to display a multi-channel setting user interface (UI) that comprises identifiers of the plurality of speakers;
an input unit configured to receive a user command; and
a controller configured to, in response to a multi-channel setting command for at least two speakers being input through the multi-channel setting UI, control the communication unit to generate a multi-channel setting command for the at least two speakers and transmit the multi-channel setting command to the at least two speakers.

12. The user terminal device of claim 11, wherein the communication unit comprises a near field communication (NFC) interface, and
the controller is configured to, in response to the user terminal being placed in contact with one of the plurality of speakers, transmit network information to the contacted speaker using Near Field Communication (NFC), and perform the pairing operation with the contacted speaker using the network information.

13. The user terminal device of claim 11, wherein the controller is configured to, in response to a button on one of the plurality of speakers being selected and receiving a network information request signal from the speaker, perform the pairing operation with the speaker by transmitting network information to the speaker.

14. The user terminal device of claim 11, wherein the controller is configured to control the communication unit to transmit a pairing completion signal to the plurality of speakers indicating that pairing is completed.

15. The user terminal device of claim 11, wherein the controller is configured to change a name of a speaker from among the plurality of speakers represented in the multi-channel setting UI according to a user input which is input through the input unit.

16. The user terminal device of claim 11, wherein the multi-channel setting UI comprises a plurality of speaker icons corresponding to the plurality of speakers and a plurality of channel icons corresponding to multiple channels, and
the controller is configured to, in response to a user command to drag and drop a first speaker icon onto a first channel icon, control the communication unit to transmit a multi-channel setting command to a first speaker corresponding to the first speaker icon to designate a first audio channel corresponding to the first channel icon to the first speaker.

17. The user terminal device of claim 11, wherein the controller is configured to control a first speaker to output an indicator indicating that the first speaker is set as a first audio channel.

18. The user terminal device of claim 16, wherein the controller is configured to, in response to a multi-touch command selecting two speaker icons corresponding to two speakers, control the communication unit to transmit an audio setting change command to the two speakers corresponding to the selected two speaker icons.

19. The user terminal device of claim 18, wherein the multi-channel setting UI comprises a graphical user interface (GUI) in a form of bar for changing an audio setting of at least two speakers which are set as the multi channels, and
the controller is configured to, in response to a user command to change an audio setting through the GUI being input, control the communication unit to transmit an audio setting change command to the at least two speakers.

20. The user terminal device of claim 11, wherein the multi-channel setting UI comprises a plurality of source icons corresponding to a plurality of source apparatuses which provide an audio source, and
the controller is configured to, in response to a first source icon being selected from among the plurality of source icons, control the communication unit to transmit speaker setting information to a first source apparatus corresponding to the first source icon.

21. A method of controlling a speaker of an audio system through a user terminal device, the method comprising:
performing a pairing operation with a plurality of speakers;
displaying a multi-channel setting user interface (UI) that comprises identifiers of the plurality of speakers;
in response to a multi-channel setting command for at least two speakers from among the plurality of speakers being input through the multi-channel setting UI, transmitting a multi-channel setting command to the at least two speakers; and
controlling the at least two speakers to output an indicator indicating that multiple channels are set.

22. A speaker comprising:
a receiver configured to receive data from a user terminal for pairing the speaker with the user terminal, and to receive a multi-channel setting command from the user terminal, the multi-channel setting command identifying a channel for the speaker and identifying another channel for another speaker;
a controller configured to set the speaker to the channel included in the multi-channel setting command; and
an outputter configured to output a notification indicating that the speaker is set to the channel included in the multi-channel setting command.

23. The speaker of claim 22, wherein the outputter is configured to output a light indicating that the speaker is set to the channel included in the multi-channel setting command.

24. The speaker of claim 22, wherein the outputter is configured to output an audio signal indicating that the speaker is set to the channel included in the multi-channel setting command.
